(19) United States
(12) Patent Application Publication
(10) Pub. No.: US 2025/0373426 A1
(43) Pub. Date: Dec. 4, 2025

(54) COORDINATE TRANSFORMS OF NETWORK CONSTELLATION SYMBOLS

(71) Applicant: Rampart Communications, Inc., Linthicum, MD (US)

(72) Inventors: Matthew Brandon Robinson, Millersville, MD (US); Daniel W. Chew, Charles Town, WV (US); Joseph Michael Ernst, Linthicum Heights, MD (US)

(21) Appl. No.: 19/216,893

(22) Filed: May 23, 2025

Related U.S. Application Data
(60) Provisional application No. 63/654,209, filed on May 31, 2024.

(51) Int. Cl. H04L 9/08; H04L 9/40

(52) U.S. Cl. CPC H04L 9/088; H04L 63/16

(57) ABSTRACT

A computing device transforms symbols in a network constellation and securely transmits data over an unsecured communications channel. The computing device obtains data points encoded in a constellation of predefined symbols. Each data point is represented by a magnitude and angle corresponding to one of the predefined symbols. The computing device obtains a set of keys and generates a first transformation for a first data point based on a first key. The first transformation applies a first rotation that adjusts the angle of the first data point based on the first key. The computing device generates a first transformed data point by applying the first transformation to the first data point and transmits a signal including the first transformed data point.

### TECHNICAL FIELD

The present disclosure relates to computer networking, especially for security at the physical layer.

### BACKGROUND

Various models (e.g., the Open Systems Interconnection (OSI) model) classify communications through a computer network into different layers of abstraction. All of the models of computer network communications are built up from the physical layer, which describes how a physical medium is manipulated to convey information. For instance, digital information (i.e., bits) may be conveyed through high/low voltages in wired signals, on/off photonic signals, high/low amplitude levels in wirelessly transmitted sinusoids, among other modes.

Symbols may encode multiple bits into a single transmission using one or more physical variables. In one example, a symbol may encode two bits in a wireless transmission by varying the phase of the transmitted signal between four different values. In other examples, the amplitude and/or phase of two orthogonal signals may be manipulated to define multiple symbols according to their In-phase (I) and Quadrature (Q) components as I-Q points in a Quadrature Amplitude Modulation (QAM) encoding scheme. A constellation of a particular QAM encoding scheme defines the possible symbol values, and determines the number of bits conveyed per symbol. For instance, a 16-QAM encoding scheme includes 16 predefined symbols at different I-Q points, with each symbol corresponding to a different set of four bits.

### BRIEF DESCRIPTION OF THE DRAWINGS

FIG. 1 is simplified block diagram of a network system configured to transform coordinates of constellation symbols, according to an example embodiment.

FIG. 2 illustrates preparing data points encoded in a Quadrature Phase Shift Keying (QPSK) constellation for transmission, according to an example embodiment.

FIG. 3 illustrates transforming, transmitting, receiving, and recovering data points based on a shared set of keys, according to an example embodiment.

FIG. 4A illustrates transforming data points encoded in a 16-Quadrature Amplitude Modulation (16-QAM) constellation, according to an example embodiment.

FIG. 4B illustrates remapping data points within a 16-QAM constellation before transforming the data points, according to an example embodiment.

FIG. 4C illustrates adjusting the magnitude of data points in a 16-QAM constellation before transforming the data points, according to an example embodiment.

FIG. 4D illustrates remapping data points in a 16-QAM constellation to a 16-PSK constellation before transforming the data points, according to an example embodiment.

FIG. 5 illustrates transforming data points by mixing adjacent data points in a data sequence, according to an example embodiment.

FIG. 6 is a flowchart illustrating operations performed by transmitter device to transform a data point encoded in a constellation, according to an example embodiment.

FIG. 7 is a flowchart illustrating operations performed by transmitter device to transform multiple data points with distinct keys, according to an example embodiment.

FIG. 8 is a flowchart illustrating operations performed by receiver device to recover a constellation symbol that has been transformed by a transmitter with a shared key, according to an example embodiment.

FIG. 9 is a block diagram of a computing device that may be configured to perform the techniques presented herein, according to an example embodiment.

### DETAILED DESCRIPTION

### Overview

A computer-implemented method is provided for transforming coordinates of constellation symbols and securely transmitting data over an unsecured communications channel. The method includes obtaining a plurality of data points encoded in a constellation of predefined symbols. Each data point in the plurality of data points is represented by a respective magnitude and a respective angle corresponding to one of the predefined symbols with a corresponding symbol magnitude and a corresponding symbol angle. The method also includes obtaining a plurality of keys and generating a first transformation for a first data point among the plurality of data points based on a first key among the plurality of keys. The first transformation applies a first rotation that adjusts the respective angle of the first data point based on the first key. The method further includes generating a first transformed data point by applying the first transformation to the first data point and transmitting a signal including the first transformed data point.

### Description of Embodiments

Transmitting a communications signal over an unsecured network link provides an opportunity for eavesdroppers to intercept information about the message being transmitted. Additionally, information about the sender and the receiver of the communications signal may be revealed through various aspects of the signal, such as the encoding format. For instance, an eavesdropper may have previous knowledge about the encoding formats of different radio systems that may be in use in a particular area. Simply recovering the encoding format of a communications signal may reveal that a known radio system is actively operating in the area, even if the information of the actual message remains encrypted at higher levels of the OSI model.

In another example, knowledge of the modulation format may enable an eavesdropper to make inferences about the link between the sender and the receiver. For instance, a higher order modulation format may require a higher Signal to Interference Ratio (SIR) for a wireless link. If the eavesdropper detects a wireless signal with a higher order modulation format (e.g., 256-QAM), then the eavesdropper may infer that the sender and the receiver are relatively close in physical proximity. Alternatively, a wireless signal with a lower order modulation format (e.g., QPSK) may indicate that the sender and receiver may be relatively far from each other or that the wireless link is noisy.

Manipulating and obscuring the communications signal at the physical layer provides security both for the information encoded in the signal and for how the information is encoded. The techniques described herein provide for transforming the predefined constellation symbols into different points on the I-Q plane according to a randomly generated key shared between the sender and receiver. The shared key allows the receiver to recover the predefined constellation symbols from the randomly distributed I-Q points transmitted by the sender.

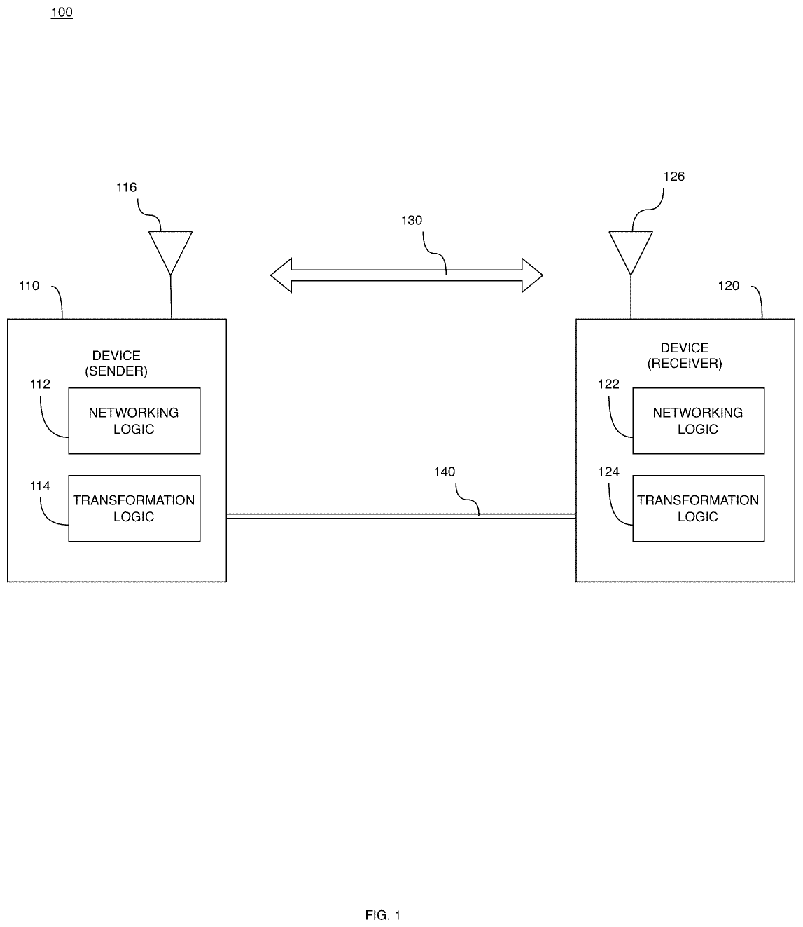

Referring now to FIG. 1, a simplified block diagram illustrates an example of a network system 100 configured to communicate information securely between computing devices. The network system 100 includes a computing device 110, which may be also be referred to herein as a sender device. The computing device 110 includes networking logic 112 that enables the computing device 110 to process communications signals and exchange information with other computing devices. The computing device 110 also includes transformation logic 114 that enables the computing device 110 to manipulate and transform communications signals according to the techniques described herein. The computing device 110 may further include a wireless network interface 116 that enables the computing device 110 to transmit/receive wireless signals to/from other computing devices.

The network system 100 also includes a computing device 120, which may be referred to herein as a receiver device. The computing device 120 includes networking logic 122 that enables the computing device 120 to process communications signals and exchange information with other computing devices. The computing device 120 also includes transformation logic 124 that enables the computing device 120 to manipulate and transform communications signals according to the techniques described herein. The computing device 120 may further include a wireless network interface 126 that enables the computing device 120 to transmit/receive wireless signals to/from other computing devices.

The network system 100 further includes at least one unsecured communications channel 130 and at least one secured communications channel 140. The unsecured communications channel 130 may be monitored by entities other than the intended participants of a communication session. For instance, the unsecured communications channel 130 may be a broadcast wireless channel that may be monitored by any computing device with a wireless network interface. Additionally, the unsecured communications channel 130 may include a publicly accessible wired link that may be subject to adversarial monitoring.

In contrast, the secured communications channel 140 only allows authorized computing devices access to the information within the secured communications channel 140. For instance, the secured communications channel 140 may be an encrypted channel or an out of band channel (e.g., direct human communication). In one example, the secured communications channel 140 may be more resource intensive than the unsecured communications channel 130. For instance, the secured communications channel 140 may require external resources (e.g., human couriers, advanced cryptographic systems, entangled quantum pairs, etc.) that limit the capacity of the secured communications channel 140. In another example, the secured communications channel 140 may be intermittently unavailable, which presents additional limitations on the information that may be exchanged over the secured communications channel 140.

In one example, the computing device 110 and/or computing device 120 may be embodied in a laptop computer, a desktop computer, a server, a network device, an Internet of Things (IoT) device, a mobile phone, or an accessory device to any of the preceding devices. The computing devices 110 and 120 may integrated into larger computing systems, such as a data center or cloud computing environment.

In another example, the networking logic 112 and the networking logic 122 may include logic that enables the computing device 110 and the computing device 120, respectively, to communicate through wired or wireless signals. For communicating with wireless signals, the networking logic 112 and the networking logic 122 may further include a software defined radio that enables the computing device 110 and the computing device 120, respectively, to adjust the parameters (e.g., frequency, amplitude, power, timing, etc.) of the wireless signals transmitted over the unsecured communications channel 130 and/or the secured communications channel 140 based on software running on the respective computing device.

In a further example, the unsecured communications channel 130 and the secured communications channel 140 connecting the computing device 110 and the computing device 120 may include a computer network, such as a Local Area Network (LAN), a Wide Area Network (WAN), a private network, a Virtual Private Network (VPN), a Metropolitan Area Network (MAN), a Personal Area Network (PAN), a Wireless LAN (WLAN), a Wireless WAN (WWAN), a cellular network, and/or combinations thereof. The unsecured communications channel 130 and the secured communications channel 140 may include segments over wired and/or wireless channels, such as Radio Frequency (RF) channels, Extremely Low Frequency (ELF) channels, Ultra Low Frequency (ULF) channels, Low Frequency (LF) channels, Medium Frequency (MF) channels, High Frequency (HF) channels, Very High Frequency (VHF) channels, Ultra High Frequency (UHF) channels, Extremely High Frequency (EHF) channels, and/or satellite channels. The unsecured communications channel 130 and the secured communications channel 140 may also include one or more segments over optical networks (e.g., based on Synchronous Optical Networking (SONET), Synchronous Digital Hierarchy (SDH), or Optical Transport Network (OTN) protocols).

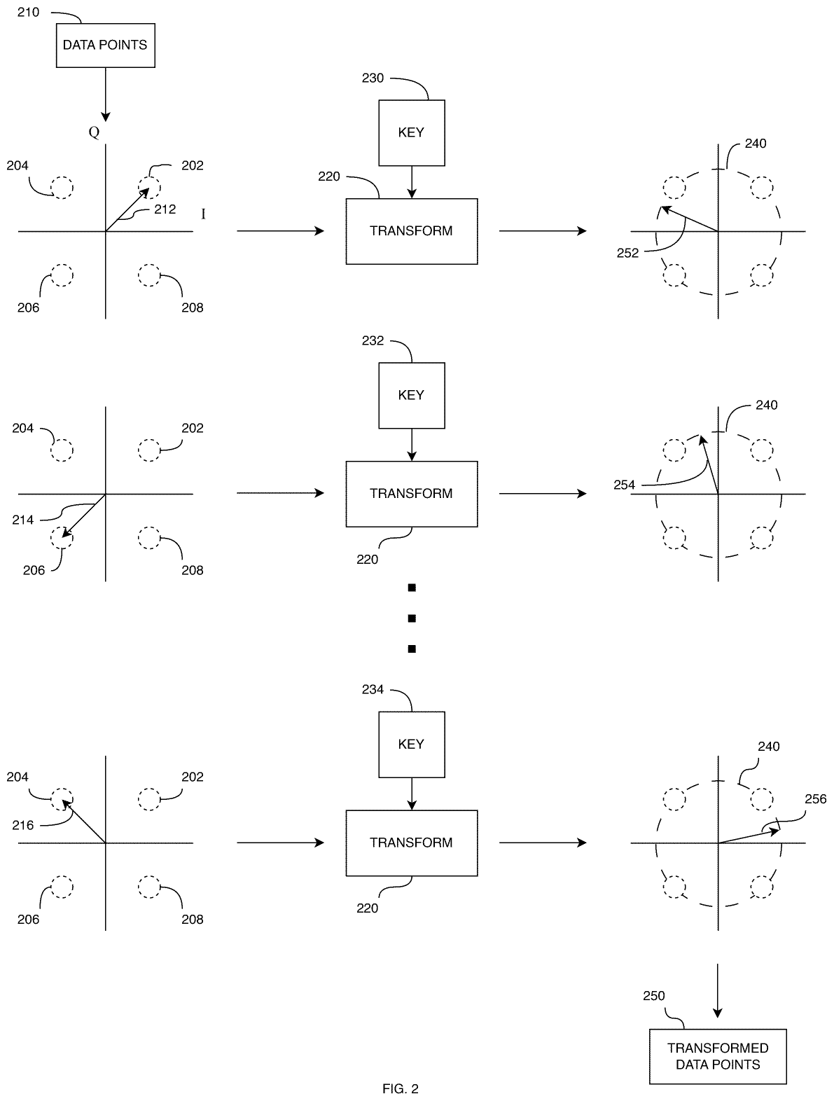

Referring now to FIG. 2, a diagram illustrates one example of a transformation of a data signal encoded in a QPSK constellation, or equivalently a 4-QAM constellation. The QPSK constellation comprises predefined symbols 202, 204, 206, and 208 at evenly spaced I-Q points in the I-Q plane. The predefined symbol 202 has a positive I value and a positive Q value of approximately equal value. The predefined symbol 204 has a negative I value and a positive Q value of approximately equal absolute value. The predefined symbol 206 has a negative I value and a negative Q value of approximately equal value. The predefined symbol 208 has a positive I value and a negative Q value of approximately equal absolute value.

Alternatively, the predefined symbols 202, 204, 206, and 208 may be defined by their respective magnitude and angle from the positive I-axis. For instance, in the QPSK constellation depicted in FIG. 2, the predefined symbol 202 may be defined by a first symbol magnitude (e.g., normalized to 1) and a first symbol angle (e.g., 45°). The predefined symbols 204, 206, and 208 may be defined by the same first symbol magnitude and respective symbol angles (e.g., 135°, 225°, and 315°).

A plurality of data points 210 includes individual data points 212, 214, and 216 that are defined by vectors corresponding to one of the predefined symbols 202, 204, 206, or 208 in the QPSK constellation. As shown in FIG. 2, the data point 212 corresponds to the predefined symbol 202, the data point 214 corresponds to the predefined symbol 206, and the data point 216 corresponds to the predefined symbol 204. In other words, the data point 212 may be represented by a magnitude and angle that corresponds to the symbol magnitude and symbol angle of the predefined symbol 202. Similarly, the data points 214 and 216 may be represented by symbol magnitudes and symbol angles corresponding to the predefined symbols 206 and 204, respectively.

Each data point in the plurality of data points 210 is transformed by the transformation 220 that rotates the angle of each data point by an amount that is determined by a separate key, while maintaining the same magnitude. The transformation 220 rotates the data point 212 based on a first key 230, the data point 214 based on a second key 232, and the data point 216 based on a third key 234. While only three data points and three keys are shown in FIG. 2, the techniques presented herein may apply to any number of data points with each data point being associated with a corresponding key.

The transformation 220 rotates the plurality of data points 210 by adjusting the angle of each data point (e.g., data points 212, 214, and 216) based on the respective key (e.g., keys 230, 232, and 234) while maintaining the same magnitude 240 of the predefined symbols 202, 204, 206, and 208. The rotation operations of the transformation 220 generate a plurality of transformed data points 250 from the plurality of data points 210. The transformation 220 rotates the data point 212 by an angle that depends on the key 230 to generate a transformed data point 252. Similarly, the transformation 220 rotates the data point 214 by an angle that depends on the key 232 to generate a transformed data point 254. The transformation 220 also rotates the data point 216 by an angle that depends on the key 234 to generate a transformed data point 256.

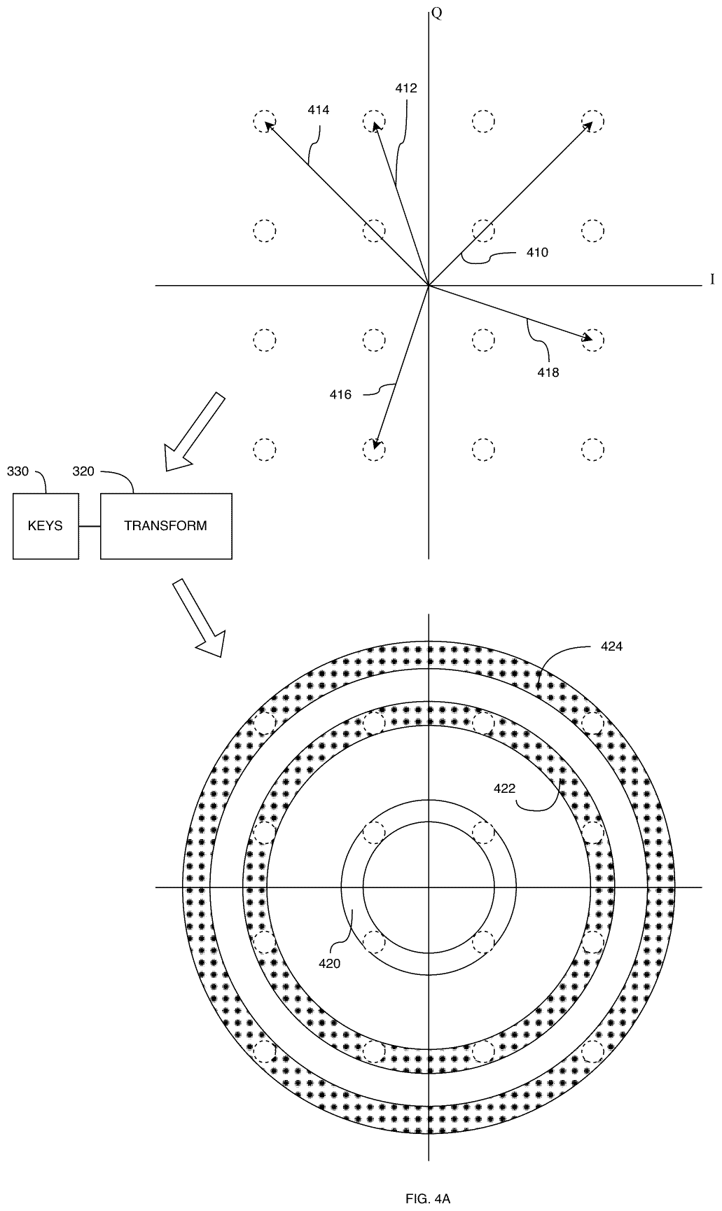

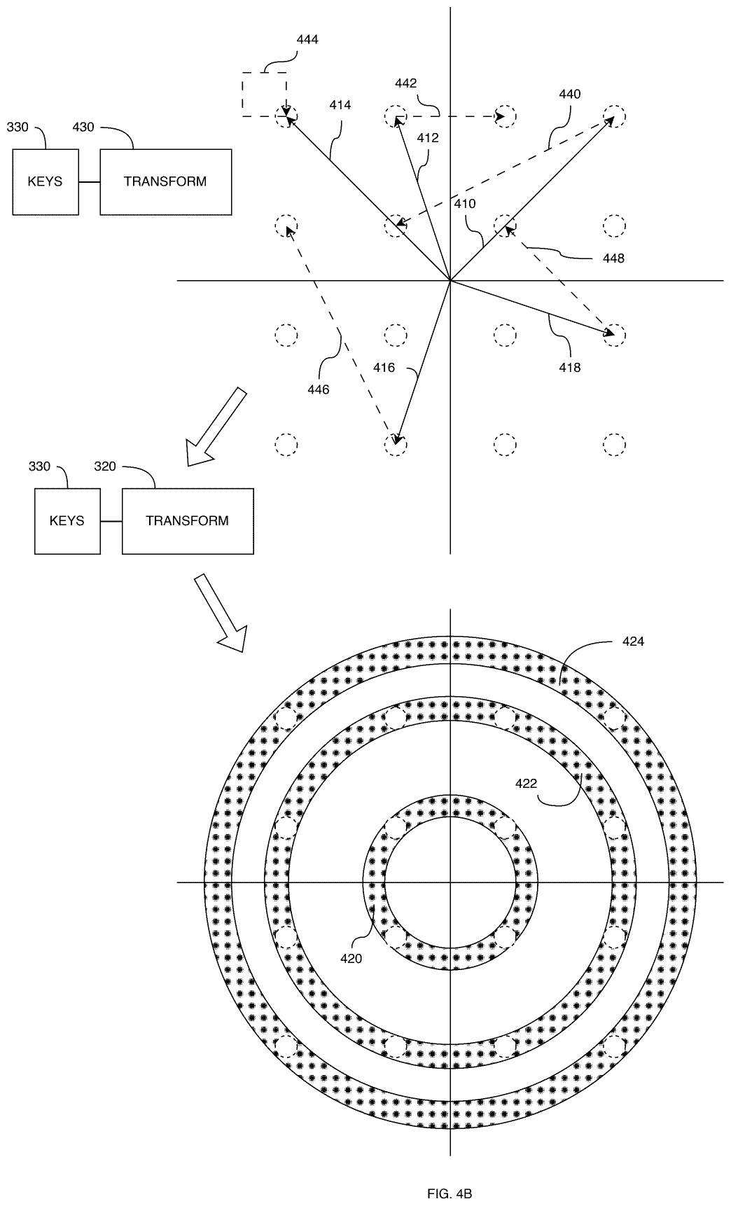

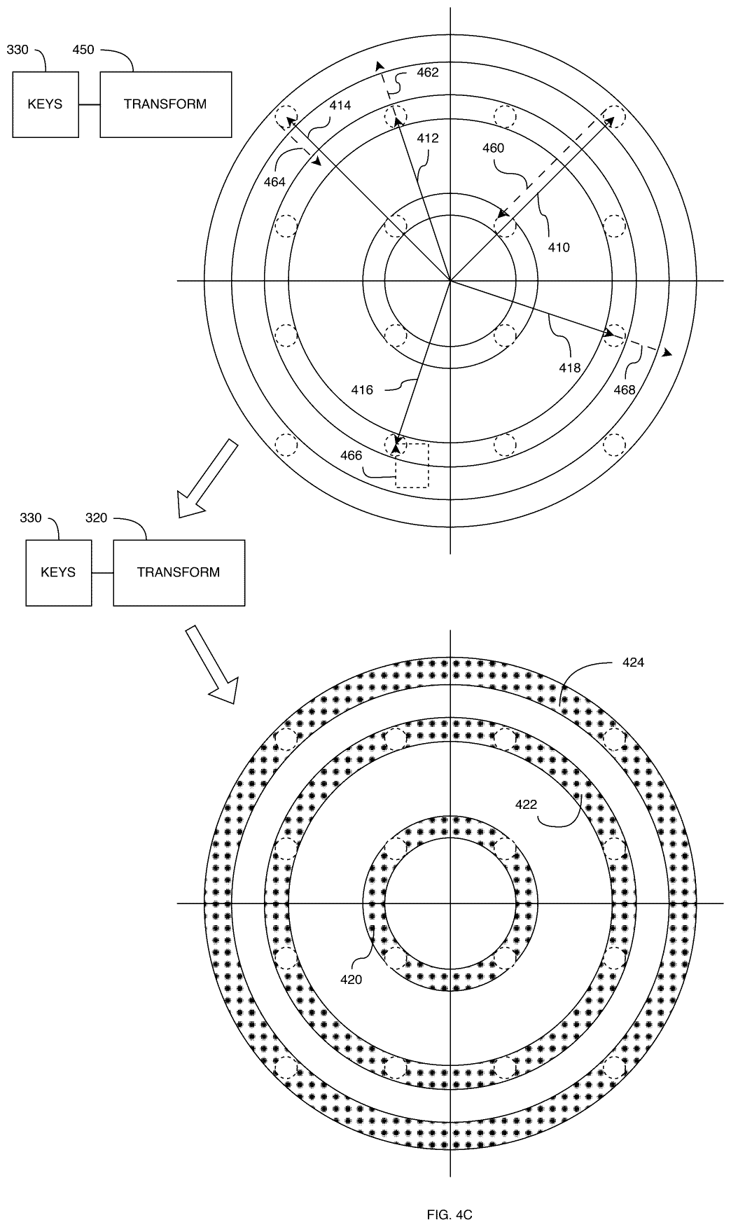

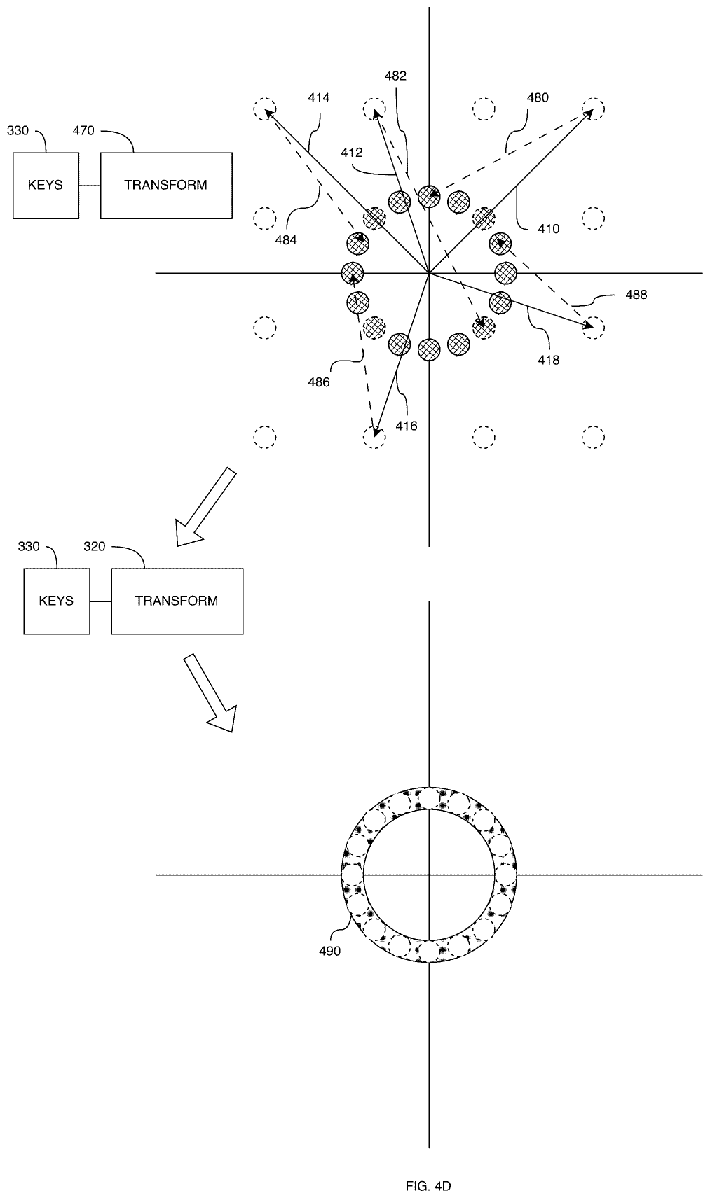

In one example, the transformation 220 is not limited to applying a key-dependent angular rotation to each data point in the plurality of data points 210. For instance, the transformation 220 may adjust the magnitude of each data point in the plurality of data points 210, as described herein with respect to FIGS. 4B, 4C, and 4D.

In another example, the keys 230, 232, and 234 may include more bits than the transformation 220 uses to determine the angle to rotate the respective data point. For instance, the key 230 may include 1024 bits, but the transformation 220 may only use 32 bits to determine the angle the data point 212 is rotated to determine the transformed data point 252. The number of bits from the keys 230, 232, and 234 may determine the granularity of the rotation performed by the transformation 220.

In a further example, the transformation 220 may apply a rotation to each data point in the plurality of data points (e.g., data points 212, 214, and 216) based on a cryptographic value derived from the corresponding key for each data point (e.g., keys 230, 232, and 234). For instance, the computing devices (e.g., computing device 110 and computing device 120) may apply the corresponding key to a nonce or a nonce and a counter to derive a cryptographical value that determines the angle of each rotation.

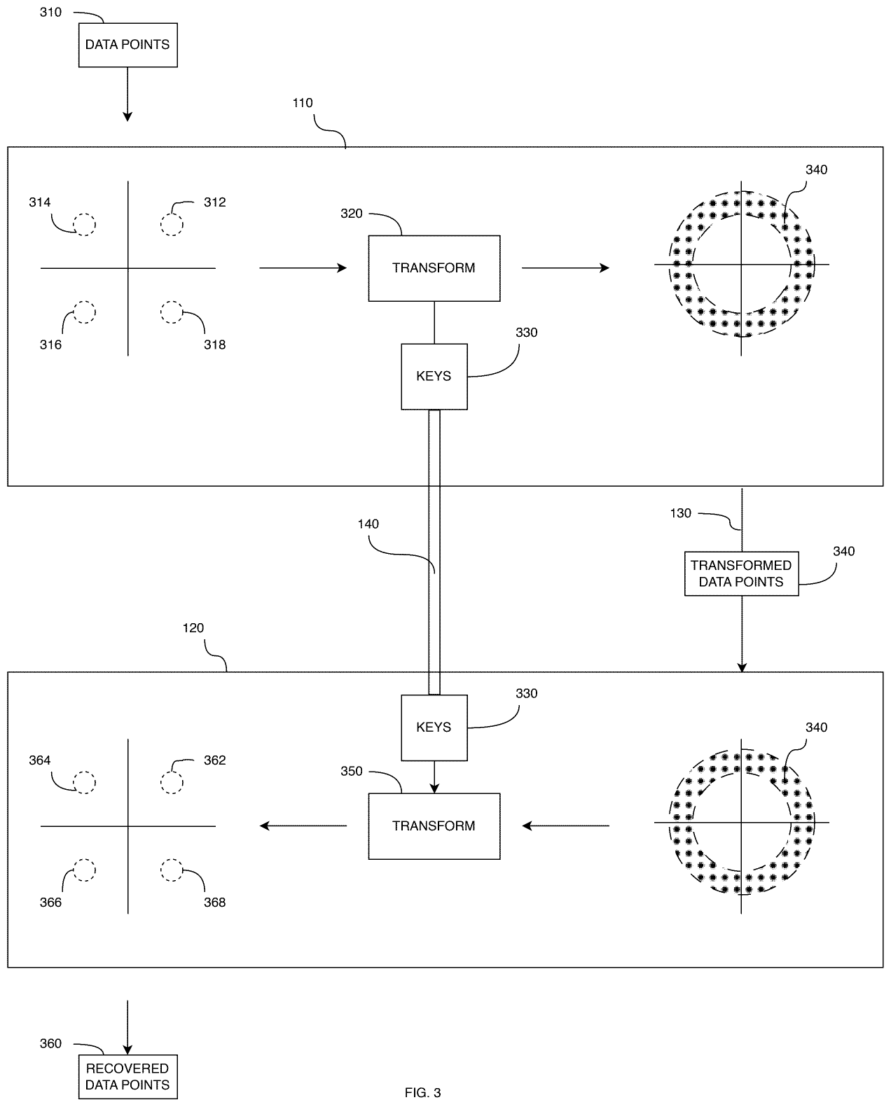

Referring now to FIG. 3, a block diagram illustrates one example of a transmission from the computing device 110 to the computing device 120 using the techniques described herein. The computing device 110 obtains a set of data points 310, which are encoded in a constellation (e.g., a QPSK constellation) with predefined symbols 312, 314, 316, and 318. The computing device 110 applies a transformation 320 to each data point in the data points 310. In one example, the transformation 320 may rotate each data point by an angle based on a corresponding key from a set of shared keys 330. In another example, the transformation 320 may apply a convolutional filter to the set of data points 310. The transformation 320 generates a set of transformed data points 340 from the set of data points 310. Because the transformation 320 does not limit the angle of the rotation, the transformed data points 340 form a ring in the I-Q plane that is not limited to the constellation symbols 312, 314, 316, and 318. Additionally, applying convolutional filter to the set of data points 310 adds inter-symbol interference to the transformed data points 340.

The transformed data points 340 are transmitted to the computing device 120 over an unsecured communications channel 130. The set of shared keys 330 is shared between the computing device 110 and the computing device 120 over the secured communications channel 140. In one example, the set of shared keys 330 may be generated at either the computing device 110 or the computing device 120 and shared with the other over the secured communications channel 140. Alternatively, the set of shared keys 330 may be generated by a third party (not shown) and shared with both the computing device 110 and the computing device 120.

The computing device 120 includes a transformation 350 that generates a set of recovered data points 360. In one example, the transformation 350 reverses the transformation 320 from the computing device 110. For instance, the transformation 350 may operate on each data point in the set of transformed data points 340 to rotate each transformed data point by an angle determined by the corresponding key in the set of shared keys 330. In other words, the transformation 350 generates a set of recovered data points 360 that are encoded in predefined symbols 362, 364, 366, and 368 in the same constellation as the data points 310 were encoded.

In another example, the transformation 350 may apply a match filter with the same convolutional filter as applied by the transformation 320 in the computing device 110. In this example, the transformation 350 may also apply further processing to mitigate inter-symbol interference in the transformed data points 340. For instance, the transformation 350 may apply a Viterbi algorithm to recover the set of recovered data points 360.

Referring now to FIG. 4A, an example of transforming a set of data points encoded in a higher order modulation format is shown. A set of data points including data point 410, 412, 414, 416, and 418 are encoded in a 16-QAM modulation format to different predefined constellation symbols. For instance, the data point 410 is depicted as encoded to a predefined symbol at an (I,Q) point of (I₄₁₀, Q₄₁₀), such as (+3, +3). Similarly, the data points 412, 414, 416, and 418 are encoded to predefined symbols at (I,Q) points of (I₄₁₂, Q₄₁₂), (I₄₁₄, Q₄₁₄), (I₄₁₆, Q₄₁₆), and (I₄₁₈, Q₄₁₈), respectively. Equivalently, the predefined symbols for each of the data points 410, 412, 414, 416, and 418 may be written in polar coordinates with a magnitude and angle, i.e., (R,θ), as (R₄₁₀, θ₄₁₀), (R₄₁₂, θ₄₁₂), (R₄₁₄, θ₄₁₄), (R₄₁₆, θ₄₁₆), and (R₄₁₈, θ₄₁₈), respectively. In the example of the 16-QAM constellation depicted in FIG. 4A, the magnitude R₄₁₀ of the data point 410 is substantially equal to the magnitude R₄₁₄ of the data point 414. Similarly, the magnitude R₄₁₂ of the data point 412, the magnitude R₄₁₆ of the data point 416, and the magnitude R₄₁₈ of the data point 418 are substantially equal to each other.

The transformation 320 rotates each data point 410, 412, 414, 416, and 418 by an arbitrary angle determined by a corresponding key from the set of shared keys 330. The arbitrary rotation of the angles of the data points 410, 412, 414, 416, and 418 (i.e., θ₄₁₀, θ₄₁₂, θ₄₁₄, θ₄₁₆, and θ₄₁₈) generates transformed data points on one of the rings 420, 422, or 424.

As shown in FIG. 4A, the transformation 320 does not adjust the magnitude of the data points 410, 412, 414, 416, and 418 (i.e., R₄₁₀, R₄₁₂, R₄₁₄, R₄₁₆, and R₄₁₈). As such, the data points 410 and 414 are transformed to a point on the ring 424, the data points 412, 416, and 418 are transformed to a point on the ring 422, and none of the data points 410, 412, 414, 416, or 418 are transformed to a point on the ring 420. With no transformed data points on the ring 420, if an adversary intercepts the transformed signal of the data points 410, 412, 414, 416, and 418, then the adversary has gained information about the data points 410, 412, 414, 416, and 418. Specifically, the adversary can eliminate four of the sixteen symbols from consideration for any of the data points 410, 412, 414, 416, or 418, lowering the barrier to additional cryptographic attacks.

Referring now to FIG. 4B, an example illustrates transforming the set of data points 410, 412, 414, 416, and 418 to further obscure the information in a signal transmission of the transformed data points. To further randomize the data points 410, 412, 414, 416, and 418, a sender device (e.g., computing device 110) applies a remapping transformation 430 that remaps the predefined symbols of each data point 410, 412, 414, 416, and 418 to a different predefined symbol within the same constellation of predefined symbols according to the corresponding key of the set of shared keys 330.

Based on the key corresponding to the data point 410 from among the set of shared keys 330, the remapping transformation 430 remaps the data point 410 by a key dependent remapping operation 440. Similarly, the remapping transformation 430 remaps the data points 412, 414, 416, and 418 based on the corresponding keys from the set of shared keys 330 by the key dependent remapping operations 442, 444, 446, and 448, respectively. In one example, the remapping transformation 430 may remap any data point to any of the predefined symbols, including the predefined symbol at which the data point was originally encoded. As shown in FIG. 4B, the data points 410, 412, 416, and 418 were remapped to different predefined symbols by the remapping operations 440, 442, 446, and 448, respectively. However, the data point 414 was remapped to the same predefined symbol by the remapping operation 444.

After the remapping transformation 430 adjusts the magnitude and angle of each of the data points 410, 412, 414, 416, and 418, the transformation 320 applies a rotation (e.g., as described with respect to FIG. 4A) and generates the transformed data points that are ready for transmission from the sender device. As shown in FIG. 4B, the transformed data points occupy all three rings 420, 422, and 424. In contrast to the example shown in FIG. 4A, the remapping transformation 430 remapped data points 410 and 418 to have a magnitude on the ring 420, and all three rings 420, 422, and 424 have at least one transformed data point.

In one example, the remapping transformation 430 adds additional bits of randomness from the set of shared keys 330 to the data points 410, 412, 414, 416, and 418 through the remapping operations 440, 442, 444, 446, and 448, respectively. In other words, the remapping transformation 430 increases the security of the transmitted signal by increasing the length of the key used to obscure the data points 410, 412, 414, 416, and 418.

In another example, the remapping transformation 430 may use a different key than the transformation 320 for each data point (e.g., data point 410) as long as both keys are associated with the data point. For instance, if the transformation 320 is configured to use 14 bits of a corresponding key from the set of shared keys 330, but the keys in the set of shared keys 330 consist of 16 bits, then the remaining two bits of each corresponding key may not be sufficient to index all of the possible remapping operations for the remapping transformation 430. In this instance, the sender device may associate a data point (e.g., data point 410) with a different key for the remapping transformation 430 and the transformation 320. Associating two different keys with the different transformations for a data point effectively doubles the key length available for each data point, increasing the security of the transmitted signal of the transformed data point.

Referring now to FIG. 4C, another example illustrates transforming the set of data points 410, 412, 414, 416, and 418 to further obscure the information in a signal transmission of the transformed data points. To further randomize the data points 410, 412, 414, 416, and 418, a sender device (e.g., computing device 110) applies a magnitude transformation 450 that adjusts the magnitude of each data point 410, 412, 414, 416, and 418 to the symbol magnitude of a different predefined symbol according to the corresponding key of the set of shared keys 330.

Based on the key corresponding to the data point 410 from among the set of shared keys 330, the magnitude transformation 450 adjusts the magnitude of the data point 410 by a key dependent operation 460. Similarly, the magnitude transformation 450 adjusts the magnitude of the data points 412, 414, and 418 based on the corresponding keys from the set of shared keys 330 by the key dependent operations 462, 464, and 468, respectively. In other words, the magnitude transformation 450 uses additional bits from the corresponding key of each data point 410, 412, 414, 416, or 418 to adjust the magnitude of each data point to one of the rings 420, 422, or 424.

In one example, the magnitude transformation 450 may adjust the magnitude of any data point to the magnitude of any of the predefined symbols, which may result in no change to the magnitude of the data point, as shown for the data point 416 and key dependent operation 466. Since the magnitude transformation 450 does not adjust the angle of the data points 410, 412, 414, 416, or 418, the adjusted data points may not fall on a predefined symbol of the 16-QAM modulation format in which the data points 410, 412, 414, 416, and 418 were originally encoded. As shown in FIG. 4C, the operations 460 and 466 adjusts the magnitude of the data points 410 and 416, respectively, so that the adjusted data points fall on a predefined symbol of the original constellation. However, the operations 462, 464, and 468 adjust the magnitudes of the data points 412, 414, and 418, respectively, to points on the I-Q plane that do not fall on one of the predefined symbols in the original constellation.

After the magnitude transformation 450 adjusts the magnitude of each of the data points 410, 412, 414, 416, and 418, the transformation 320 applies a rotation (e.g., as described with respect to FIG. 4A) and generates the transformed data points that are ready for transmission from the sender device. As shown in FIG. 4C, the transformed data points occupy all three rings 420, 422, and 424. In contrast to the example shown in FIG. 4A, the magnitude transformation 450 adjusted the magnitude of data point 410 to have a magnitude on the ring 420, and all three rings 420, 422, and 424 have at least one transformed data point.

In one example, the magnitude transformation 450 adds additional bits of randomness from the set of shared keys 330 to the data points 410, 412, 414, 416, and 418 through the key dependent operations 460, 462, 464, 466, and 468, respectively. In other words, the magnitude transformation 450 increases the security of the transmitted signal by increasing the length of the key used to obscure the data points 410, 412, 414, 416, and 418.

In another example, the magnitude transformation 450 may use a different key than the transformation 320 for each data point (e.g., data point 410) as described with respect to FIG. 4B. However, since multiple symbols may occupy the same ring 420, 422, or 424, the number of bits required to index all of the possible key dependent operations 460, 462, 464, 466, and 468 is typically smaller than the number of bits required to index the possible remapping operations 440, 442, 444, 446, and 448, as shown in FIG. 4B.

For instance, if the transformation 320 is configured to use 14 bits of a corresponding key from the set of shared keys 330, and the keys in the set of shared keys 330 consist of 16 bits, then the remaining two bits of each corresponding key may not be sufficient to index all of the possible remapping operations for the remapping transformation 430, but two bits may be sufficient to index all of the possible magnitude adjustment operations for the magnitude transformation 450.

Referring now to FIG. 4D, a further example illustrates transforming the set of data points 410, 412, 414, 416, and 418 to further obscure the information in a signal transmission of the transformed data points. To further randomize the data points 410, 412, 414, 416, and 418, a sender device (e.g., computing device 110) applies a remapping transformation 470 that remaps the predefined symbols of each data point 410, 412, 414, 416, and 418 to a new constellation (e.g., a Phase Shift Key (PSK) constellation) with different predetermined symbols according to the corresponding key of the set of shared keys 330.

Based on the key corresponding to the data point 410 from among the set of shared keys 330, the remapping transformation 470 remaps the data point 410 by a key dependent remapping operation 480. Similarly, the remapping transformation 470 remaps the data points 412, 414, 416, and 418 based on the corresponding keys from the set of shared keys 330 by the key dependent remapping operations 482, 484, 486, and 488, respectively. In one example, the new constellation may include predetermined symbols that overlap with the predefined symbols of the original constellation. The remapping transformation 470 may remap any data point to any of the predetermined symbols, including a predetermined symbols that overlaps with a predefined symbol from the original constellation, e.g., the predefined symbol at which the data point was originally encoded. As shown in FIG. 4D, the data points 410, 414, 416, and 418 were remapped to predetermined symbols that do not overlap with the predefined symbols of the original constellation by the remapping operations 480, 484, 486, and 488, respectively. However, the data point 412 was remapped to a predetermined symbol of the new constellation that overlaps with a predefined symbol of the original constellation by the remapping operation 482.

After the remapping transformation 470 adjusts the magnitude and angle of each of the data points 410, 412, 414, 416, and 418, the transformation 320 applies a rotation (e.g., as described with respect to FIG. 4A) and generates the transformed data points that are ready for transmission from the sender device. As shown in FIG. 4D, the transformed data points only occupy a single ring 490, further obscuring the original constellation in which the data points 410, 412, 414, 416, and 418 were originally encoded.

In one example, the remapping transformation 470 adds additional bits of randomness from the set of shared keys 330 to the data points 410, 412, 414, 416, and 418 through the remapping operations 480, 482, 484, 486, and 488, respectively. In other words, the remapping transformation 470 increases the security of the transmitted signal by increasing the length of the key used to obscure the data points 410, 412, 414, 416, and 418. Additionally, the remapping transformation 470 may use a different key than the transformation 320 for each data point (e.g., data point 410) as long as both keys are associated with the data point, as described with respect to FIG. 4B and FIG. 4C.

In another example, the remapping transformation 470 may remap between constellations with a different number of magnitude levels. As shown in FIG. 4D, the remapping transformation 470 remaps from a 16-QAM with three magnitude levels (i.e., rings 420, 422, 424) to a 16-PSK with one magnitude level (i.e., ring 490) to decrease the number of magnitude levels. In another instance, the remapping transformation 470 may remap to increase the number magnitude levels, such as remapping from a 16-PSK constellation with one magnitude level to a 16-Amplitude PSK (16-APSK) constellation with two magnitude levels. In general, the remapping transformation 470 may remap from any format constellation to any other format constellation with at least as many symbols. In other words, the new constellation may have more predetermined symbols than the original constellation has predefined symbols to encode the data points.

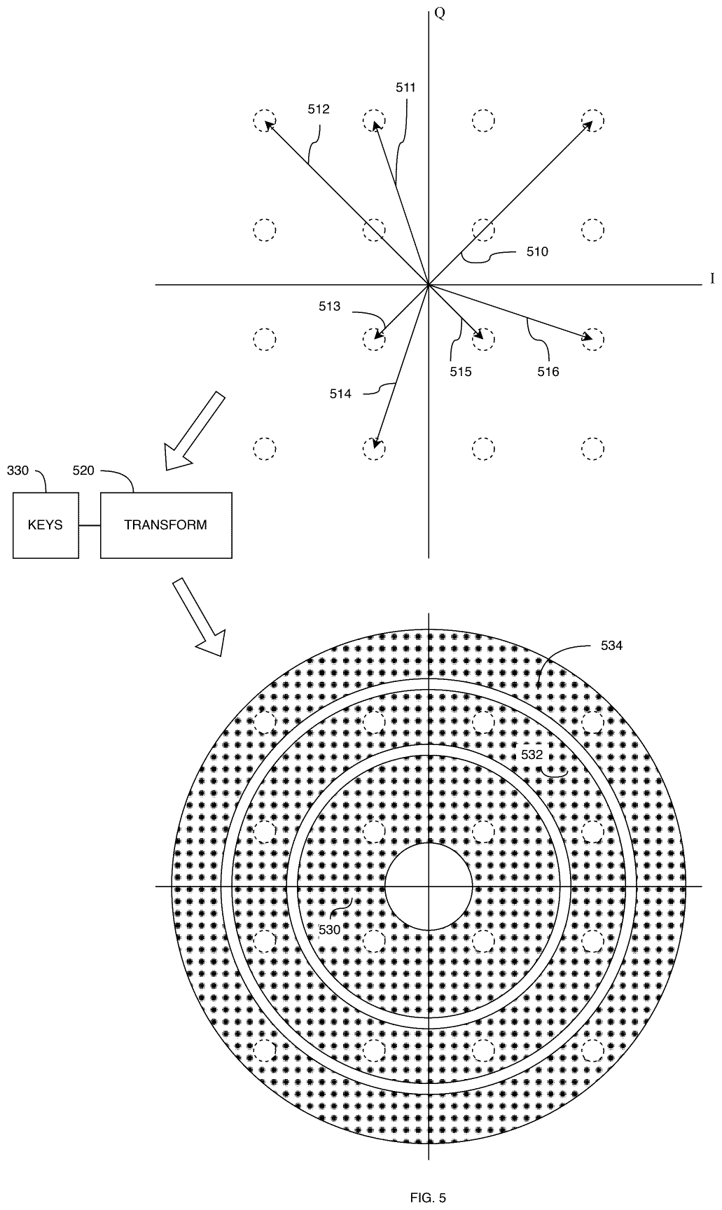

Referring now to FIG. 5, an example illustrates a transformation that mixes pairs of data points to further obscure information in a signal transmission of the transformed data points. To obscure information about individual data points 510, 511, 512, 513, 514, 515, and 516, a sender device (e.g., computing device 110) mixes at least two of the data points 510, 511, 512, 513, 514, 515, and 516 with a mixing transformation 520 based on the set of shared keys 330. By mixing information from at least two data points 510, 511, 512, 513, 514, 515, and 516, the mixing transformation 520 adjusts the magnitude of the transformed symbols to expand the rings 530, 532, and 534 in the I-Q plane when the symbols are rotated as described herein.

In one example, the mixing transformation 520 may rotate a first data point (e.g., data point 510) in the I-Q plane by a first angle based on a first key associated with the first data point. The mixing transformation 520 may rotate a second data point (e.g., data point 511) in the I-Q plane by a second angle based on a second key associated with the second data point. The mixing transformation 520 may mix information from the two data points by an amount that is based on the first key, the second key, a combination of the first key and the second, or by a predetermined amount that may not be based on the set of shared keys 330.

In another example, the mixing transformation 520 applies a matrix M to a combination of two data points (e.g., data points 510 and 511) to mix the magnitude and phase of the two data points. The matrix M may also rotate the angle of the two data points individually based on the respective keys from the set of shared keys 330. For instance, the matrix M may take the form:

$$M = [ \begin{matrix}{e}^{i α} cos φ & {e}^{- i β} sin φ \\ - {e}^{- i β} sin φ & {e}^{- i α} cos φ\end{matrix} ] , \qquad ( 1 )$$

where α determines the angle that a first data point (e.g., data point 510) rotates, β determines the angle that a second data point (e.g., data point 511) rotates, and φ determines the amount of mixing between the first data point and the second data point.

The parameters of the matrix M may be determined by one or both of the respective keys from the set of shared keys 330. For instance, the angle parameter α may be determined by the key associated with the first data point and the angle parameter β may be determined by the key associated with the second data point. A combination of the two respective keys may determine the mixing parameter φ within a predetermined range (e.g., from 0 to π/4) to determine the amount of mixing between the two data points. Alternatively, the mixing parameter φ may be a predetermined parameter that is set for all of the combinations of data points.

In some instances, the matrix M that is applied by the mixing transformation 520 may be a unitary matrix that preserves the power when transmitting the first data point and the second data point. Alternatively, the mixing transformation 520 may include applying a non-unitary matrix M′. A non-unitary matrix M′ may be generated based on a perturbation of a unitary matrix, such as the identity matrix. For instance, the matrix M′ may take the form:

$${M}^{′} = [ \begin{matrix}1 & δ \\ δ & 1\end{matrix} ] , \qquad ( 2 )$$

where δ is a perturbation that moves the matrix M′ away from the unitary identity matrix. A non-unitary mixing matrix M′ effectively adds noise to the transmission of the data points based on the perturbation δ.

The mixing transformation 520 may reduce the amplifier distortion of nonlinear amplifiers by decreasing the Peak-to-Average-Power Ratio (PAPR) for transmitting signals representing the data points. In some instances, the noise loss added by the non-unitary matrix M′ in the mixing transformation 520 may be offset by reduced distortion losses due to the lower PAPR, leading to an overall increase in efficiency. In other words, decreasing the PAPR by using a non-unitary mixing matrix M′ may be worth the small amount of additional noise from a non-unitary mixing matrix M′, leading to an overall increase in efficiency.

In some instances, the non-unitary elements of a non-unitary mixing matrix (e.g., the perturbation δ in the mixing matrix M′) may be defined/bound by the decrease in PAPR. Similarly, the size of mixing matrix in the mixing transformation 520 (i.e., the number of symbols mixed in the mixing transformation 520) may be bound/defined by an amount of acceptable noise at a receiver device computing device 120.

In a further example, the mixing transformation 520 may be applied iteratively to further obscure the information in the data points 510, 511, 512, 513, 514, 515, and 516. For instance, the sender device may sequentially apply the matrix M more than once to further mix the first data point and the second data point. Each iteration may rotate the individual data points by the same or different amounts in each iteration. In other words, the angle parameters α and β may vary across iterations of the matrix M based on the respective keys of the set of shared keys 330. Additionally, the sender device may apply another rotation to the data points 510, 511, 512, 513, 514, 515, and 516 after the mixing transformation 520 based on the respective keys from the set of shared keys 330.

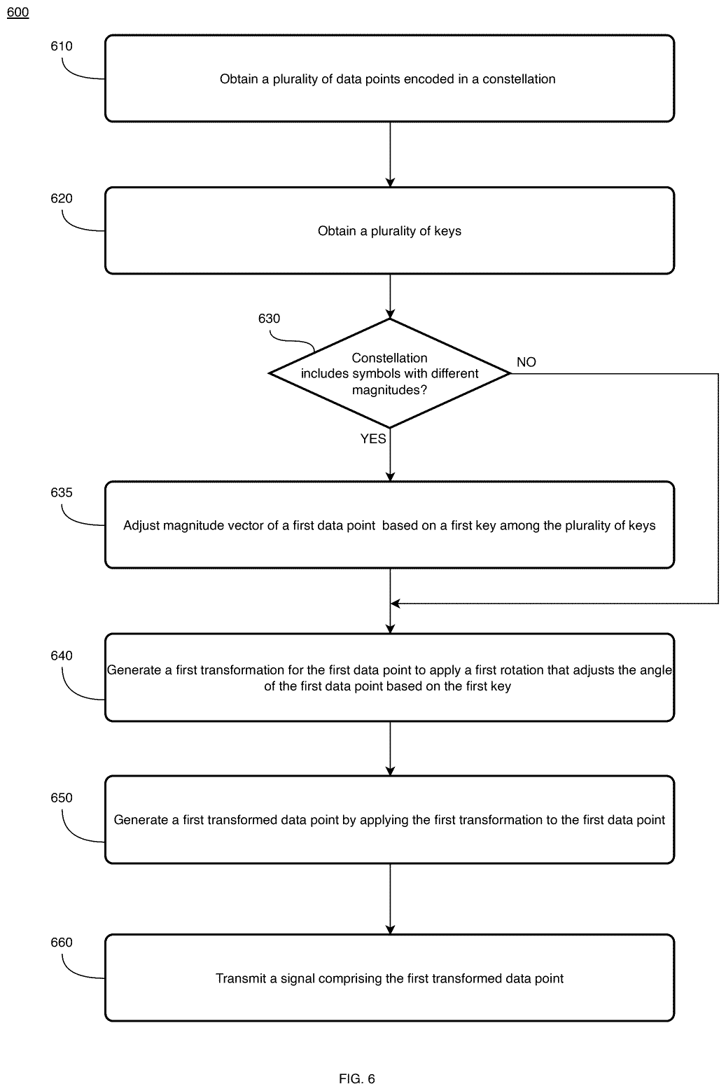

Referring now to FIG. 6, a flowchart illustrates an example process 600 performed by a sender device (e.g., computing device 110) to secure a data point for transmission at the physical layer. At 610, the sender device obtains a plurality of data points encoded in a constellation of predefined symbols. Each data point is represented by a respective magnitude and respective angle that corresponds to one of the predefined symbols with a corresponding symbol magnitude and a corresponding symbol angle. In one example, the plurality of data points may be I-Q points encoded in a constellation of a QAM or a PSK modulation format.

At 620, the sender device obtains a plurality of keys. In one example, the plurality of keys may include cryptographic keys and/or bit strings generated from cryptographic keys. In another example, each key in the plurality of keys may comprise a plurality of bits (e.g., 128 bits, 256 bits, etc.) that are randomly or pseudo-randomly determined. In another example, the plurality of keys may be shared over a secured communications channel (e.g., secured communications channel 140) with one or more receiver devices (e.g., computing device 120) that are authorized to receive and recover the plurality of data points.

At 630, the sender device determines whether the constellation includes predefined symbols with different magnitude values for the predefined symbols in the I-Q plane. For instance, APSK constellations include predefined symbols with different magnitude values. In contrast, PSK constellations include predefined symbols that differ only in angle (i.e., phase), but not in magnitude level.

If the constellation in which the plurality of data points is encoded includes predefined symbols with different magnitude levels, as determined at 630, then the sender device adjusts the magnitude level of a first data point based on a first key among the plurality of keys at 635. In one example, the sender device may also adjust the phase of the first data point based on the first key. For instance, the sender device may remap the first data point to a different symbol in a new constellation or the original constellation based on the first key, and the different symbol may be represented by a new magnitude and/or angle in comparison to the magnitude and angle of the original symbol representing the first data point.

At 640, the sender device generates a first transformation for the first data point among the plurality of data points. The first transformation applies a first rotation that adjusts the angle of the first data point based on the first key corresponding to the first data point. In one example, the first transformation may include a magnitude adjustment and/or an angle adjustment from 635. In another example, the angle of the first rotation may be based on a cryptographic value derived from the first key. For instance, the angle of the first rotation may be based on a value derived from the combination of the first key with a nonce and/or counter.

At 650, the sender device generates a first transformed data point by applying the first transformation to the first data point. In one example, the first transformed data point may be represented by an I-Q point that does not correspond to one of the predefined symbols of the constellation encoding the plurality of data points. At 660, the sender device transmits a signal comprising the first transformed data point. In one example, the sender device may generate multiple transformed data points for inclusion in the transmitted signal. Each transformed data point would be generated based on a separate transformation based on a separate key among the plurality of keys.

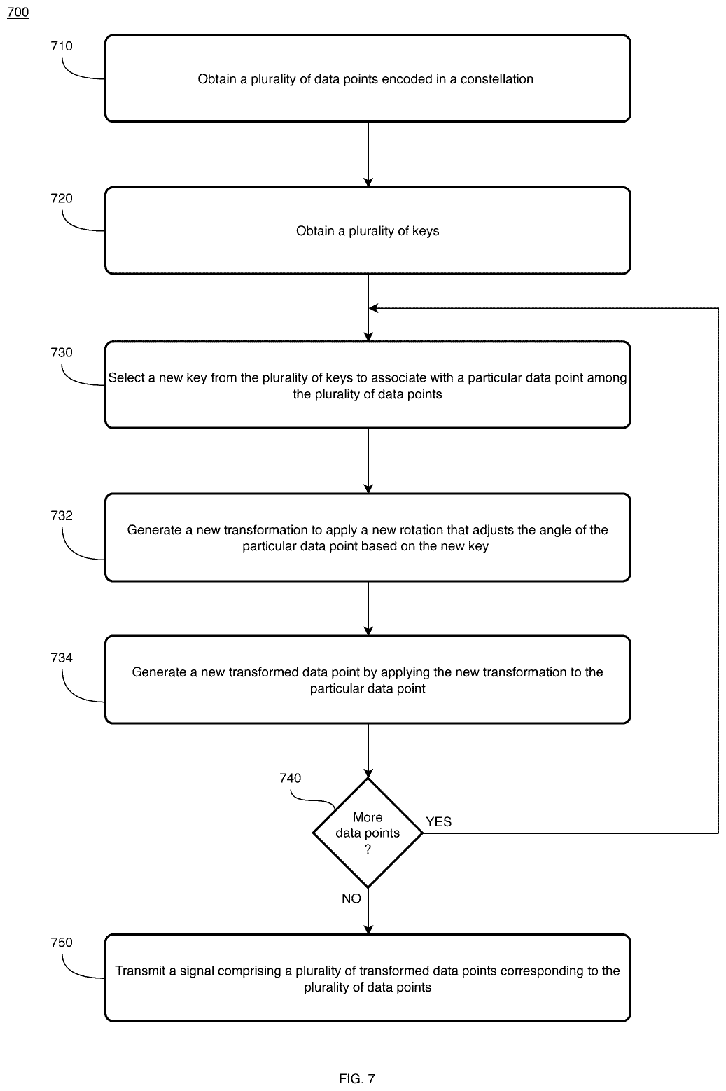

Referring now to FIG. 7, a flowchart illustrates another example process 700 performed by a sender device (e.g., computing device 110) to secure transmission of multiple data points at the physical layer. At 710, the sender device obtains a plurality of data points encoded in a constellation of predefined symbols. Each data point is represented by a respective magnitude and respective angle that corresponds to one of the predefined symbols with a corresponding symbol magnitude and a corresponding symbol angle. In one example, the plurality of data points may be I-Q points encoded in a constellation of a QAM or a PSK modulation format.

At 720, the sender device obtains a plurality of keys. In one example, the plurality of keys may include cryptographic keys and/or bit strings generated from cryptographic keys. In another example, each key in the plurality of keys may comprise a plurality of bits (e.g., 128 bits, 256 bits, etc.) that are randomly or pseudo-randomly determined. In another example, the plurality of keys may be shared over a secured communications channel (e.g., secured communications channel 140) with one or more receiver devices (e.g., computing device 120) that are authorized to receive and recover the plurality of data points.

At 730, the sender device begins processing a particular data point among the plurality of data points by selecting a new key from the plurality of keys. In one example, the selected key may comprise multiple keys to associate with the particular data point. At 732, the sender device generates a new transformation to apply a new rotation that adjusts the angle of the particular data point based on the associated key. In one example, the new transformation may also adjust the magnitude of the particular data point. At 734, the sender device generates a new transformed data point by applying the new transformation to the particular data point. In one example, the new transformed data point may be represented by an I-Q point that does not correspond to one of the predefined symbols of the constellation encoding the plurality of data points.

At 740, the sender device determines whether any more data points in the plurality of data points have not been transformed. If at least one additional data point has not been transformed, then the process 700 returns to 730 to select a new key for another data point in the plurality of data points. In one example, the sender devices cycles through 730, 732, and 734 for each data point in the plurality of data points to generate a plurality of transformed data points.

Once all of the data points in the plurality of data points have been transformed into corresponding transformed data points, as determined at 740, the sender device transmits a signal comprising a plurality of transformed data points corresponding to the plurality of data points at 750. In one example, the signal may be transmitted over an unsecured communications channel. In another example, the signal may be transmitted over a wired or over a wireless communications link.

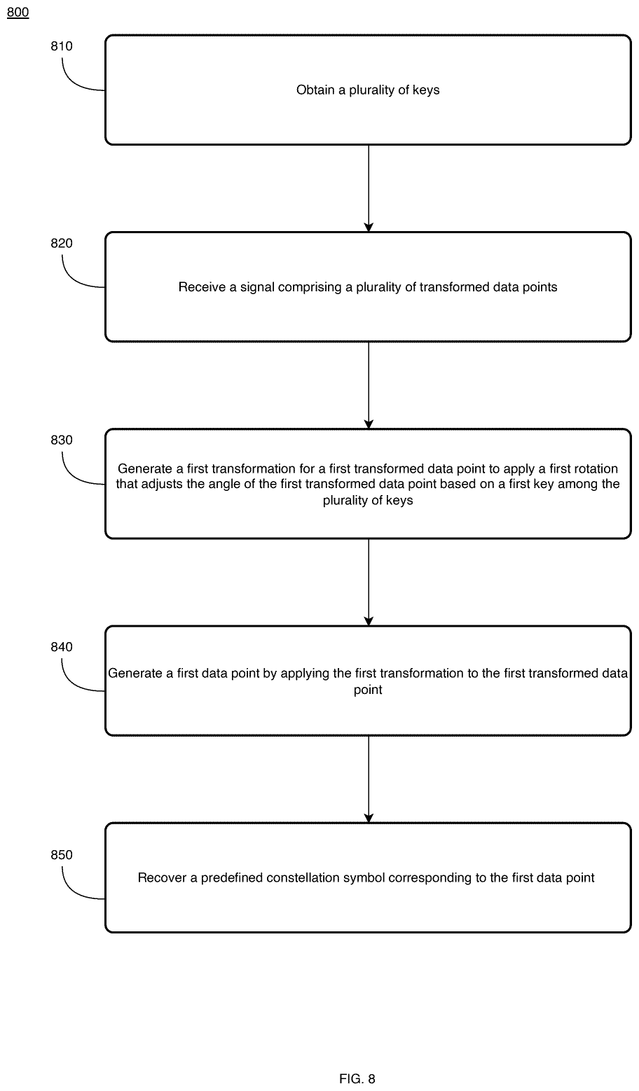

Referring now to FIG. 8, a flowchart illustrates an example process 800 performed by a receiver device (e.g., computing device 120) to recover a data point from a transmission that is secured at the physical layer. At 810, the receiver device obtains a plurality of keys. In one example, the plurality of keys may include cryptographic keys and/or bit strings generated from cryptographic keys. In another example, each key in the plurality of keys may comprise a plurality of bits (e.g., 128 bits, 256 bits, etc.) that are randomly or pseudo-randomly determined. In another example, the plurality of keys may be obtained over a secured communications channel (e.g., secured communications channel 140).

At 820, the receiver device receives a signal comprising a plurality of transformed data points. In one example, the plurality of transformed data points are I-Q points that are spread in one or more rings on the I-Q plane. In another example, the transformed data points in the plurality of transformed data points do not correspond to predefined symbols of a constellation based on a modulation format (e.g., QAM, PSK, etc.)

At 830, the receiver device generates a first transformation for a first transformed data point among the plurality of transformed data points. The first transformation applies a first rotation that adjusts the angle of the first transformed data point based on a first key among the plurality of keys. In one example, the first transformation may also adjust the magnitude of the first transformed data point.

At 840, the receiver device generates a first data point by applying the first transformation to the first transformed data point. In one example, the first transformation may adjust the magnitude and the angle of the first transformed data point separately or concurrently. In another example, the first transformation may comprise more than one transformation operation. At 850, the receiver device recovers a symbol corresponding to the first data point. The recovered symbol corresponds to a predefined symbol in a constellation according to a modulation format. In one example, the predefined symbol corresponding to the recovered symbol may correspond to a bit sequence that communicates information to the receiver device from a sender device. In another example, the receiver device may recover multiple data points the received signal. Each data point would be recovered based on a separate transformation based on a separate key among the plurality of keys.

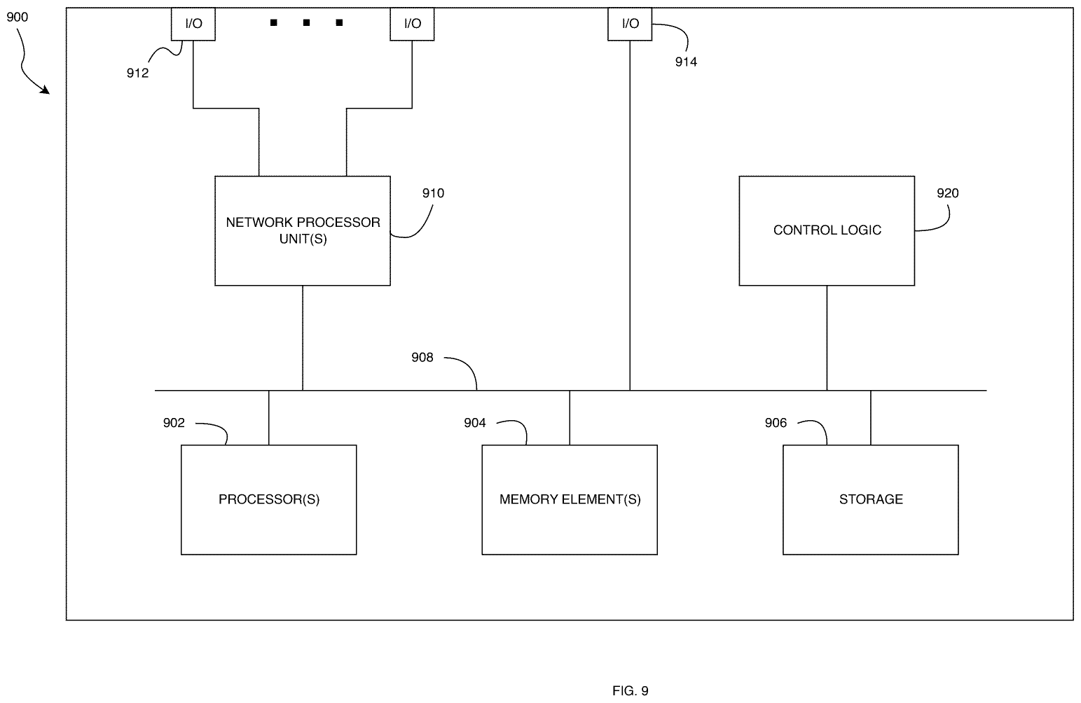

Referring now to FIG. 9, a hardware block diagram depicts a computing device 900 that may perform functions associated with operations described herein in connection with the techniques depicted in FIGS. 1-3, 4A, 4B, 4C, 4D, 5, 6, and 7. In various embodiments, a computing device, such as computing device 900 or any combination of computing devices 900, may be configured as any entity/entities as discussed for the techniques depicted in connection with FIGS. 1-3, 4A, 4B, 4C, 4D, 5, 6, and 7 in order to perform operations of the various techniques discussed herein. In some instances, one or more computing devices 900 (e.g., servers) may be deployed in a cloud or distributed computing environment to perform one or more of the techniques described herein.

In at least one embodiment, the computing device 900 may include one or more processor(s) 902, one or more memory element(s) 904, storage 906, a communication bus 908, one or more network processor unit(s) 910 interconnected with one or more network input/output (I/O) interface(s) 912, and control logic 920. In various embodiments, instructions associated with logic for computing device 900 may overlap in any manner and are not limited to the specific allocation and/or operations described herein.

In at least one embodiment, processor(s) 902 is/are at least one hardware processor configured to execute various tasks, operations, and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information, etc.) from one state or thing to another state or thing. Any of potential processing elements, microprocessors, digital signal processors, floating point gate arrays (FPGAs), graphical processor units (GPUs), secure processors, baseband signal processors, modems, PHY elements, controllers, systems, managers, logic, and/or machines described herein can be construed as being encompassed within the broad term ‘processor.’

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, communication bus 908 can be configured as an interface that enables one or more elements of computing device 900 to communicate in order to exchange information and/or data. Communication bus 908 can be implemented with any architecture designed for passing control, data, and/or information between processors, memory elements/storage, peripheral devices, and/or any other hardware and/or software components that may be configured for computing device 900. In at least one embodiment, communication bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface card(s), optical (e.g., SONET, SDH, OTN) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc., to facilitate operations for various embodiments described herein. In various embodiments, network I/O interface(s) 912 can be configured as one or more Ethernet port(s), SONET port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, touch screen, microphone or microphone array, camera, video capture device, and/or other suitable input and/or output device now known or hereafter developed. In some instances, external devices may also include portable computer readable (non-transitory) storage media such as database systems, flash memory drives, portable optical or magnetic disks, and/or other memory cards. In some instances, external devices may include a mechanism to display data to a user, such as a computer monitor, a display screen, an audio speaker, and/or other output device.

In various embodiments, control logic 920, can include instructions that, when executed, cause processor(s) 902 to perform operations, which can include, but not be limited to, providing overall control operations of computing devices; interacting with other entities, systems, etc., described herein; maintaining and/or interacting with stored data, information, parameters, etc. (e.g., memory element(s), storage, data structures, databases, tables, etc.); combinations thereof, and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), secure memory module, tamper-proof memory, application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure; all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in an Application Specific Integrated Circuit (ASIC), Digital Signal Processing (DSP) instructions, software (potentially inclusive of object code and/or source code), etc.) for execution by one or more processor(s), and/or other similar machines. Generally, memory element(s) 904 and/or storage 906 may store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, and/or the like that are executed to carry out operations in accordance with the teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, flash drives, and/or smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium.

Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/6G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of, ‘one or more of, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and ‘one or more of can be represented using the’ (s)′ nomenclature (e.g., one or more element(s)).

In summary, the techniques presented herein provide for transmitting and receiving data that is secured at the physical layer. The data may be secured by transforming the I-Q coordinates of each data point based on a key corresponding to the data point. By transforming each data point based on a separate key, the data is spread across the I-Q, obscuring the data from potential eavesdroppers. Additionally, various embodiments adjust the magnitude of the transformed data points to provide control over the power characteristics of the transmitted signal.

In some aspects, the techniques described herein relate to a method including: obtaining a plurality of data points encoded in a constellation of predefined symbols, each data point in the plurality of data points represented by a respective magnitude and a respective angle corresponding to one of the predefined symbols with a corresponding symbol magnitude and a corresponding symbol angle; obtaining a plurality of keys; generating a first transformation for a first data point among the plurality of data points, the first transformation applying a first rotation that adjusts the respective angle of the first data point based on a first key among the plurality of keys; generating a first transformed data point by applying the first transformation to the first data point; and transmitting a signal including the first transformed data point.

In some aspects, the techniques described herein relate to a method, further including: generating a second transformation for a second data point among the plurality of data points, the second transformation adjusting the respective angle of the second data point based on a second key among the plurality of keys, wherein the second key is different than the first key; and generating a second transformed data point by applying the second transformation to the second data point, wherein the signal further includes the second transformed data point.

In some aspects, the techniques described herein relate to a method, further including: applying at least one iteration of an iterative transformation to generate a first iterated data point and a second iterated data point, wherein each iteration of the iterative transformation includes: applying a first In-phase/Quadrature (I/Q) rotation to the first data point based on the first key to generate a first rotated data point; applying a second I/Q rotation to the second data point based on the second key to generate a second rotated data point; and applying a mixing transformation to the first rotated data point and the second rotated data to generate a first mixed data point and a second mixed data point, wherein a subsequent iteration of the iterative transformation operates on the first mixed data point and the second mixed data point, and wherein the first mixed data point of a final iteration is the first iterated data point and the second mixed data point of the final iteration is the second iterated data point, wherein generating the first transformed data point includes applying the first transformation to the first iterated data point, and generating the second transformed data point includes applying the second transformation to the second iterated data point.

In some aspects, the techniques described herein relate to a method, wherein the first transformation adjusts the respective angle of the first data point to a value between the corresponding symbol angles of the predefined symbols in the constellation of predefined symbols.

In some aspects, the techniques described herein relate to a method, wherein the constellation of predefined symbols includes at least two predefined symbols with different values of the corresponding symbol magnitude.

In some aspects, the techniques described herein relate to a method, wherein the first transformation further adjusts the respective magnitude of the first data point based on the first key.

In some aspects, the techniques described herein relate to a method, wherein the first transformation adjusts the respective magnitude of the first data point by: determining a new predefined symbol among the constellation of predefined symbols based on a portion of the first key, the new predefined symbol with a new symbol magnitude and a new symbol angle; and shifting the respective magnitude of the first data point to the new symbol magnitude before applying the first rotation, wherein the first transformation further shifts the respective angle of the first data point to the new symbol angle before applying the first rotation.

In some aspects, the techniques described herein relate to a method, wherein the first transformation adjusts the respective magnitude of the first data point by: selecting a new symbol magnitude from among the corresponding symbol magnitudes of the predefined symbols in the constellation; and shifting the respective magnitude of the first data point to the new symbol magnitude before applying the first rotation.

In some aspects, the techniques described herein relate to a method, wherein the first transformation adjusts the respective magnitude of the first data point by: selecting a new constellation of predetermined symbols, wherein each predetermined symbol in the new constellation is defined by a corresponding new symbol magnitude and a corresponding new symbol angle; determining a first predetermined symbol among the new constellation of predetermined symbols based on the first key, the first predetermined symbol defined by a new symbol magnitude and a new symbol angle; and shifting the respective magnitude of the first data point to the new symbol magnitude before applying the first rotation, wherein the first transformation further shifts the respective angle of the first data point to the new symbol angle before applying the first rotation.

In some aspects, the techniques described herein relate to an apparatus including: a network interface configured to transmit signals to one or more computing devices; and a processor configured to: obtain a plurality of data points encoded in a constellation of predefined symbols, each data point in the plurality of data points represented by a respective magnitude and a respective angle corresponding to one of the predefined symbols with a corresponding symbol magnitude and a corresponding symbol angle; obtain a plurality of keys; generate a first transformation for a first data point among the plurality of data points, the first transformation applying a first rotation that adjusts the respective angle of the first data point based on a first key among the plurality of keys; generate a first transformed data point by applying the first transformation to the first data point; and cause the network interface to transmit a signal including the first transformed data point.

In some aspects, the techniques described herein relate to an apparatus, wherein the processor is further configured to: generate a second transformation for a second data point among the plurality of data points, the second transformation adjusting the respective angle of the second data point based on a second key among the plurality of keys, wherein the second key is different than the first key; and generate a second transformed data point by applying the second transformation to the second data point, wherein the signal further includes the second transformed data point.

In some aspects, the techniques described herein relate to an apparatus, wherein the processor is further configured to generate the first transformation to adjust the respective angle of the first data point to a value between the corresponding symbol angles of the predefined symbols in the constellation of predefined symbols.

In some aspects, the techniques described herein relate to an apparatus, wherein the processor is further configured to generate the first transformation to adjust the respective magnitude of the first data point based on the first key.

In some aspects, the techniques described herein relate to an apparatus, wherein the first transformation adjusts the respective magnitude of the first data point by: determining a new predefined symbol among the constellation of predefined symbols based on a portion of the first key, the new predefined symbol with a new symbol magnitude and a new symbol angle; and shifting the respective magnitude of the first data point to the new symbol magnitude before applying the first rotation, wherein the first transformation further shifts the respective angle of the first data point to the new symbol angle before applying the first rotation.

In some aspects, the techniques described herein relate to an apparatus, wherein the first transformation adjusts the respective magnitude of the first data point by: selecting a new symbol magnitude from among the corresponding symbol magnitudes of the predefined symbols in the constellation; and shifting the respective magnitude of the first data point to the new symbol magnitude before applying the first rotation.

In some aspects, the techniques described herein relate to an apparatus, wherein the first transformation adjusts the respective magnitude of the first data point by: selecting a new constellation of predetermined symbols, wherein each predetermined symbol in the new constellation is defined by a corresponding new symbol magnitude and a corresponding new symbol angle; determining a first predetermined symbol among the new constellation of predetermined symbols based on the first key, the first predetermined symbol defined by a new symbol magnitude and a new symbol angle; and shifting the respective magnitude of the first data point to the new symbol magnitude before applying the first rotation, wherein the first transformation further shifts the respective angle of the first data point to the new symbol angle before applying the first rotation.

In some aspects, the techniques described herein relate to one or more non-transitory computer readable storage media encoded with software including computer executable instructions and, when the software is executed on a processor of a computing device, operable to cause the processor to: obtain a plurality of data points encoded in a constellation of predefined symbols, each data point in the plurality of data points represented by a respective magnitude and a respective angle corresponding to one of the predefined symbols with a corresponding symbol magnitude and a corresponding symbol angle; obtain a plurality of keys; generate a first transformation for a first data point among the plurality of data points, the first transformation applying a first rotation that adjusts the respective angle of the first data point based on a first key among the plurality of keys; generate a first transformed data point by applying the first transformation to the first data point; and transmit a signal including the first transformed data point.

In some aspects, the techniques described herein relate to one or more non-transitory computer readable storage media, wherein the software is further operable to cause the processor to: generate a second transformation for a second data point among the plurality of data points, the second transformation adjusting the respective angle of the second data point based on a second key among the plurality of keys, wherein the second key is different than the first key; and generate a second transformed data point by applying the second transformation to the second data point, wherein the signal further includes the second transformed data point. 19.

In some aspects, the techniques described herein relate to one or more non-transitory computer readable storage media, wherein the software is further operable to cause the processor to: select a new symbol magnitude from among the corresponding symbol magnitudes of the predefined symbols in the constellation; and shift the respective magnitude of the first data point to the new symbol magnitude before applying the first rotation.

In some aspects, the techniques described herein relate to one or more non-transitory computer readable storage media, wherein the software is further operable to cause the processor to: select a new constellation of predetermined symbols, wherein each predetermined symbol in the new constellation is defined by a corresponding new symbol magnitude and a corresponding new symbol angle; determine a first predetermined symbol among the new constellation of predetermined symbols based on the first key, the first predetermined symbol defined by a new symbol magnitude and a new symbol angle; and shift the respective magnitude of the first data point to the new symbol magnitude before applying the first rotation, wherein the first transformation further shifts the respective angle of the first data point to the new symbol angle before applying the first rotation.

Each example embodiment disclosed herein has been included to present one or more different features. However, all disclosed example embodiments are designed to work together as part of a single larger system or method. The disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining a plurality of data points encoded in a constellation of predefined symbols, each data point in the plurality of data points represented by a respective magnitude and a respective angle corresponding to one of the predefined symbols with a corresponding symbol magnitude and a corresponding symbol angle;
obtaining a plurality of keys;
generating a first transformation for a first data point among the plurality of data points, the first transformation applying a first rotation that adjusts the respective angle of the first data point based on a first key among the plurality of keys;
generating a first transformed data point by applying the first transformation to the first data point; and
transmitting a signal comprising the first transformed data point.

2. The method of claim 1, further comprising:
generating a second transformation for a second data point among the plurality of data points, the second transformation adjusting the respective angle of the second data point based on a second key among the plurality of keys, wherein the second key is different than the first key; and
generating a second transformed data point by applying the second transformation to the second data point,
wherein the signal further comprises the second transformed data point.

3. The method of claim 2, further comprising:
applying at least one iteration of an iterative transformation to generate a first iterated data point and a second iterated data point, wherein each iteration of the iterative transformation comprises:
applying a first In-phase/Quadrature (I/Q) rotation to the first data point based on the first key to generate a first rotated data point;
applying a second I/Q rotation to the second data point based on the second key to generate a second rotated data point; and
applying a mixing transformation to the first rotated data point and the second rotated data point to generate a first mixed data point and a second mixed data point, wherein a subsequent iteration of the iterative transformation operates on the first mixed data point and the second mixed data point, and wherein the first mixed data point of a final iteration is the first iterated data point and the second mixed data point of the final iteration is the second iterated data point,
wherein generating the first transformed data point comprises applying the first transformation to the first iterated data point, and generating the second transformed data point comprises applying the second transformation to the second iterated data point.

4. The method of claim 1, wherein the first transformation adjusts the respective angle of the first data point to a value between the corresponding symbol angles of the predefined symbols in the constellation of predefined symbols.

5. The method of claim 1, wherein the constellation of predefined symbols includes at least two predefined symbols with different values of the corresponding symbol magnitude.

6. The method of claim 1, wherein the first transformation further adjusts the respective magnitude of the first data point based on the first key.

7. The method of claim 6, wherein the first transformation adjusts the respective magnitude of the first data point by:
determining a new predefined symbol among the constellation of predefined symbols based on a portion of the first key, the new predefined symbol with a new symbol magnitude and a new symbol angle; and
shifting the respective magnitude of the first data point to the new symbol magnitude before applying the first rotation,
wherein the first transformation further shifts the respective angle of the first data point to the new symbol angle before applying the first rotation.

8. The method of claim 6, wherein the first transformation adjusts the respective magnitude of the first data point by:
selecting a new symbol magnitude from among the corresponding symbol magnitudes of the predefined symbols in the constellation; and
shifting the respective magnitude of the first data point to the new symbol magnitude before applying the first rotation.

9. The method of claim 6, wherein the first transformation adjusts the respective magnitude of the first data point by:
selecting a new constellation of predetermined symbols, wherein each predetermined symbol in the new constellation is defined by a corresponding new symbol magnitude and a corresponding new symbol angle;
determining a first predetermined symbol among the new constellation of predetermined symbols based on the first key, the first predetermined symbol defined by a new symbol magnitude and a new symbol angle; and
shifting the respective magnitude of the first data point to the new symbol magnitude before applying the first rotation,
wherein the first transformation further shifts the respective angle of the first data point to the new symbol angle before applying the first rotation.

10. An apparatus comprising:
a network interface configured to transmit signals to one or more computing devices; and
a processor configured to:
obtain a plurality of data points encoded in a constellation of predefined symbols, each data point in the plurality of data points represented by a respective magnitude and a respective angle corresponding to one of the predefined symbols with a corresponding symbol magnitude and a corresponding symbol angle;
obtain a plurality of keys;
generate a first transformation for a first data point among the plurality of data points, the first transformation applying a first rotation that adjusts the respective angle of the first data point based on a first key among the plurality of keys;
generate a first transformed data point by applying the first transformation to the first data point; and
cause the network interface to transmit a signal comprising the first transformed data point.

11. The apparatus of claim 10, wherein the processor is further configured to:
generate a second transformation for a second data point among the plurality of data points, the second transformation adjusting the respective angle of the second data point based on a second key among the plurality of keys, wherein the second key is different than the first key; and
generate a second transformed data point by applying the second transformation to the second data point,
wherein the signal further comprises the second transformed data point.

12. The apparatus of claim 10, wherein the processor is further configured to generate the first transformation to adjust the respective angle of the first data point to a value between the corresponding symbol angles of the predefined symbols in the constellation of predefined symbols.

13. The apparatus of claim 10, wherein the processor is further configured to generate the first transformation to adjust the respective magnitude of the first data point based on the first key.

14. The apparatus of claim 13, wherein the first transformation adjusts the respective magnitude of the first data point by:
determining a new predefined symbol among the constellation of predefined symbols based on a portion of the first key, the new predefined symbol with a new symbol magnitude and a new symbol angle; and
shifting the respective magnitude of the first data point to the new symbol magnitude before applying the first rotation,
wherein the first transformation further shifts the respective angle of the first data point to the new symbol angle before applying the first rotation.

15. The apparatus of claim 13, wherein the first transformation adjusts the respective magnitude of the first data point by:
selecting a new symbol magnitude from among the corresponding symbol magnitudes of the predefined symbols in the constellation; and
shifting the respective magnitude of the first data point to the new symbol magnitude before applying the first rotation.

16. The apparatus of claim 13, wherein the first transformation adjusts the respective magnitude of the first data point by:
selecting a new constellation of predetermined symbols, wherein each predetermined symbol in the new constellation is defined by a corresponding new symbol magnitude and a corresponding new symbol angle;
determining a first predetermined symbol among the new constellation of predetermined symbols based on the first key, the first predetermined symbol defined by a new symbol magnitude and a new symbol angle; and
shifting the respective magnitude of the first data point to the new symbol magnitude before applying the first rotation,
wherein the first transformation further shifts the respective angle of the first data point to the new symbol angle before applying the first rotation.

17. One or more non-transitory computer readable storage media encoded with software comprising computer executable instructions and, when the software is executed on a processor of a computing device, operable to cause the processor to:
obtain a plurality of data points encoded in a constellation of predefined symbols, each data point in the plurality of data points represented by a respective magnitude and a respective angle corresponding to one of the predefined symbols with a corresponding symbol magnitude and a corresponding symbol angle;
obtain a plurality of keys;
generate a first transformation for a first data point among the plurality of data points, the first transformation applying a first rotation that adjusts the respective angle of the first data point based on a first key among the plurality of keys;
generate a first transformed data point by applying the first transformation to the first data point; and
transmit a signal comprising the first transformed data point.

18. The one or more non-transitory computer readable storage media of claim 17, wherein the software is further operable to cause the processor to:
generate a second transformation for a second data point among the plurality of data points, the second transformation adjusting the respective angle of the second data point based on a second key among the plurality of keys, wherein the second key is different than the first key; and
generate a second transformed data point by applying the second transformation to the second data point,
wherein the signal further comprises the second transformed data point.

19. The one or more non-transitory computer readable storage media of claim 17, wherein the software is further operable to cause the processor to:
select a new symbol magnitude from among the corresponding symbol magnitudes of the predefined symbols in the constellation; and
shift the respective magnitude of the first data point to the new symbol magnitude before applying the first rotation.

20. The one or more non-transitory computer readable storage media of claim 17, wherein the software is further operable to cause the processor to:
select a new constellation of predetermined symbols, wherein each predetermined symbol in the new constellation is defined by a corresponding new symbol magnitude and a corresponding new symbol angle;
determine a first predetermined symbol among the new constellation of predetermined symbols based on the first key, the first predetermined symbol defined by a new symbol magnitude and a new symbol angle; and
shift the respective magnitude of the first data point to the new symbol magnitude before applying the first rotation,
wherein the first transformation further shifts the respective angle of the first data point to the new symbol angle before applying the first rotation.
